(19) United States
(12) Patent Application Publication
(10) Pub. No.: US 2014/0122291 A1
(43) Pub. Date: May 1, 2014

(54) Bargaining Through a User-Specific Item List

(71) Applicant: MICROSOFT CORPORATION, Redmond, WA (US)

(72) Inventors: Anand Sampathkumaran, Redmond, WA (US); Kalyan Sayyaparaju, Redmond, WA (US); Sangeetha Ananthasankar, Kirkland, WA (US); Gayathri Chandrasekaran, Bellevue, WA (US); Tanuja Bompada, Redmond, WA (US)

(73) Assignee: MICROSOFT CORPORATION, Redmond, WA (US)

(21) Appl. No.: 13/665,337

(22) Filed: Oct. 31, 2012

(51) Int. Cl. G06Q 30/00

(52) U.S. Cl. 705/26.8

(57) ABSTRACT

Systems, methods, and computer-readable storage media for providing a vendor-independent item list to a computer user are presented. A vendor-independent item list is provided in which a plurality of computer users each have a corresponding item list upon which a computer user can add entries for various items offered by vendors. Upon receiving a user-initiated indication that the user would potentially like to add one or more items from a currently-viewed web page, a process identifies item information from the web page and presents the item information (including information for at least one item) to the computer user. Upon receiving a selection from the computer user of a presented item, an entry for that selected item is added to the computer user's item list. The computer user and one or more vendors can interact with offers and counter-offers.

### CROSS-REFERENCE TO RELATED APPLICATIONS

The present application is related to U.S. patent application Ser. No. ______, entitled “User-Advertiser Bargaining in Search Results” [attorney docket no. 337093.01] and U.S. patent application Ser. No. ______, entitled “Bargaining Through a User-Specific Item List” [attorney docket no. 337201.01].

### BACKGROUND

At least part of the motivation for a computer user to “surf” the Internet is to locate items (products, services, and the like) that the computer user would like to obtain. To that end, there are many Internet sites that offer the items to the computer users that visit, much like a virtual, online store. Some of these online stores are directed to a particular niche (such as focused on a particular brand, or focused on a particular type of product) while others try to offer as many types of goods and services as possible. Whether a computer user prefers to purchase from the niche market sites or the “department store” sites, it is still advantageous for the computer user to perform comparisons between sites when making purchase decisions. Moreover, while the department store sites (those that offer a wide variety of items—both products and services) are generally well known and easily found, the niche market sites are often overlooked or unknown to the typical computer user, thus making it likely that the computer user won't be able to carry out an effective comparison.

Though the computer user can navigate the Internet between the various merchants' sites to perform comparisons, ultimately it is up to the computer user to remember which site offered a desired product/service at the best price. At best, this is inconvenient for the computer user, but more likely the computer user won't be able to encounter all of the various options to make an informed purchasing decision.

### SUMMARY

According to aspects of the disclosed subject matter, a method for providing a vendor-independent item list to a computer user is presented. A vendor-independent item list is provided in which a plurality of computer users, each having a corresponding item list, can add entries for various items offered by vendors. Upon receiving a user-initiated indication that the user would potentially like to add one or more items from a currently-viewed web page, a process identifies item information from the web page and presents the item information (including information for at least one item) to the computer user. Upon receiving a selection from the computer user of a presented item, an entry for that selected item is added to the computer user's item list.

According to additional aspects of the disclosed subject matter, computer-readable media bearing computer-executable instructions that carry out a method for providing a vendor-independent item list to a computer user are presented. The method includes hosting a vendor-independent item list in which a plurality of computer users, each have a corresponding item list, can add entries for various item offered by vendors. Upon receiving a user-initiated indication that the user would potentially like to add one or more items from a currently-viewed web page, a process identifies item information from the web page and presents the item information (including information for at least one item) to the computer user. Upon receiving a selection from the computer user of a presented item, an entry for that selected item is added to the computer user's item list.

According to still further aspects of the disclosed subject matter, a computer-implemented system for facilitating a vendor-independent item list for a computer user is presented. In addition to a processor and a memory, in which the processor executes instructions stored in the memory as part of or in conjunction with additional components to facilitate the vendor-independent item list for a computer user, the computer-implemented system includes other, additional components including (but not limited to) a communication component by which the computer system communicates with the computer user and one or more vendors over a network. Further included in the computer-implemented system is a web page scanning module that scans a web page viewed and identifies item information (corresponding to items for acquisition by the computer user) on the scanned web page. The item information is presented to a user and, upon selection, the computer-implemented system causes that an entry corresponding to the selected item is added to the computer user's item list.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 shows an illustrative diagram of an exemplary networked environment in which aspects of the disclosed subject matter may be carried out;

FIGS. 2A and 2B are pictorial diagrams illustrating a browser view showing a portion of an exemplary search results page as generated by a search engine that provides an item list for a computer user;

FIG. 3 is a pictorial diagram illustrating an exemplary browser view that includes notification tools according to aspects of the disclosed subject matter;

FIG. 4 is a flow diagram illustrating an exemplary routine for adding an advertised item from a search results page to an item list corresponding to the computer user;

FIG. 5 is a flow diagram illustrating an exemplary routine for monitoring a user amount associated with an item on the computer user's item list and notifying the computer user when the current price of the item is at or below the user amount;

FIG. 6 is a flow diagram illustrating an exemplary routine in which an advertiser can provide a counter-offer to the computer user with regard to a user amount included with an item on the computer user's item list;

FIG. 7 is a flow diagram illustrating an exemplary routine for monetizing a computer user's use of an item list;

FIG. 8 is a block diagram illustrating a search engine configured to provide a computer user with an item list;

FIG. 9A is a pictorial diagram illustrating an browser view of a web page with a user-actionable control configured to initiate a process to extract item information from the currently-viewed web page;

FIG. 9B is a pictorial diagram illustrating an alternative browser view of the web page of FIG. 9A in which item on the currently-viewed web page are automatically identified;

FIG. 10 is a pictorial diagram illustrating an item information view containing item information extracted from the currently-viewed web page of FIG. 9A;

FIG. 11 is a flow diagram illustrating an exemplary routine for adding entries corresponding to items from a web page onto a computer user's item list from a confirmation view; and

FIG. 12 is a block diagram illustrating exemplary components of a computing system suitably configured to implement aspects of the disclosed subject matter.

### DETAILED DESCRIPTION

For purposed of clarity, the use of the term “exemplary” in this document should be interpreted as serving as an illustration or example of something, and it should not be interpreted as an ideal and/or leading illustration of that thing. An “item”, as used with regard to a user's item list and in regard to subject matter of an advertisement, refers to a product and/or service that a user may purchase, lease, and/or acquire. The term “item list” should be interpreted as being a list or set of entries corresponding to items that have been added at the direction of a computer user to the item list. A service (such as an online search engine) maintains plurality of item lists for a corresponding plurality of computer users.

A “sponsored advertisement”, as used in this document, refers to a hyperlink to a product and/or service and which is presented in the form of a search results, and that sponsored (paid for) by an advertiser. Advertisers pay for sponsored advertisements in order to have search results referencing the product/service that is offered by the advertiser.

The phrase “add an item to an item list” and “add an entry for the item on an item list” are used interchangeably and refer to the act of placing an entry on an item for the item.

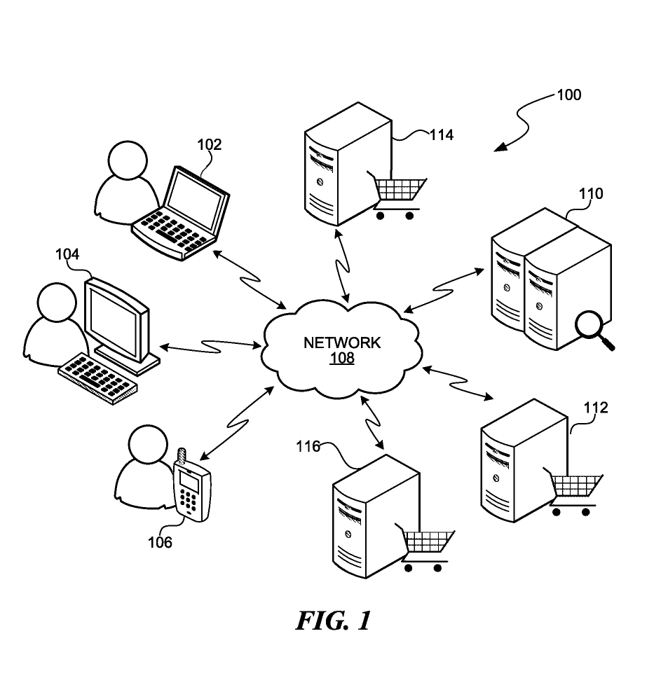

Turning to FIG. 1, this figure shows an illustrative diagram of an exemplary networked environment 100 in which aspects of the disclosed subject matter may be carried out. The illustrative environment 100 includes one or more user computers, such as user computers 102-106, connected to a network 108, such as the Internet, a wide area network or WAN, and the like. Also connected to the network 108 is a search engine 110 configured to provide search results to search queries, and further configured to provide and manage a computer user's item list as will be described in greater detail below.

Those skilled in the art will appreciate that, generally speaking, a search engine 110 corresponds to an online service hosted on one or more computers, or computing systems, located and/or distributed throughout the network 108. The search engine 110 receives and responds to search queries submitted over the network 108 from various computer users, such as the computer users that connected to user computers 102-106. In particular, responsive to receiving a search query from a computer user, the search engine 110 obtains search results information related and/or relevant to the received search query (as defined by the terms of search query.) The search results information includes search results, i.e., references (typically in the form of hyperlinks) to relevant and/or related content available from various network locations, including content-hosting sites located throughout the network 108.

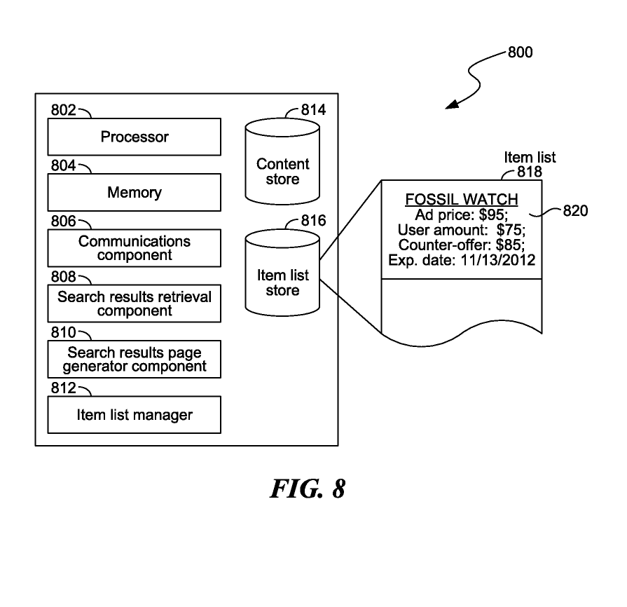

As those skilled in the art will appreciate, content-hosting sites host or store content that is available and/or accessible to computer users (via user computers) over the network 108. Through the user of processes that crawl the network scanning for content, the search engine 110 will be aware of at least some of the content hosted on the many target sites located throughout the network 108. Once content is located, the search engine 110 will store information regarding the hosted content in a content store (e.g., content store 814 of FIG. 8). The search engine 110 draws from the content store when obtaining search results information in response to receiving a search query from a computer user.

The search results information obtained by the search engine 110 in response to a search query may further include (by illustration and not limitation) related and/or recommended alternative search queries, data and facts regarding the subject matter of the search query, images pertaining to the subject matter of the search query, products and/or services related/relevant to the search query, advertisements, and the like. Further still, the search results information will typically include a plurality of advertisements directed to products and/or services available from one or more advertisers, represented by advertiser devices 112-116. As those skilled in the art will appreciate, quite frequently the search services offered by a search engine 110 will appear as a free service, i.e., a computer user is not charged a pecuniary amount for the search results provided in response to a search query (also synonymously referred to as a search request). Instead, the search results (generated in one or more a search results pages) are combined with advertisements such that the search service is “ad supported,” i.e., financed by advertisements paid for by advertisers.

Often a computer user's search query and the corresponding search results will be directed to products and/or services that the computer user desires to obtain. Naturally, relevant search results will be directed to the products or services. While a search results page can provide a list of many products or services that satisfy a search query, if a computer user wishes to compare the items identified in the search results the process becomes one of navigating (i.e., the computer user's browser “following” a hyperlink by displaying the referenced content) to a product/service web site, viewing the information, and then returning to the search results page to view another product and/or service. This holds true for search results, sponsored advertisements, as well as typical advertisements. According to aspects of the disclosed subject matter, in order to enhance the usability of the search engine 110 for the computer user as well as enable advertisers to better target their advertising money to those computer users that are truly interested in their products or services, the search engine 110 hosts a plurality of item lists. Each list of the plurality of item lists corresponds to a specific computer user (or a specific group of computer users) and allows the corresponding computer user to place/store an item onto the computer user's item list. Details regarding adding an item to a computer user's item list, as well as managing a computer user's item list is set forth in greater detail below.

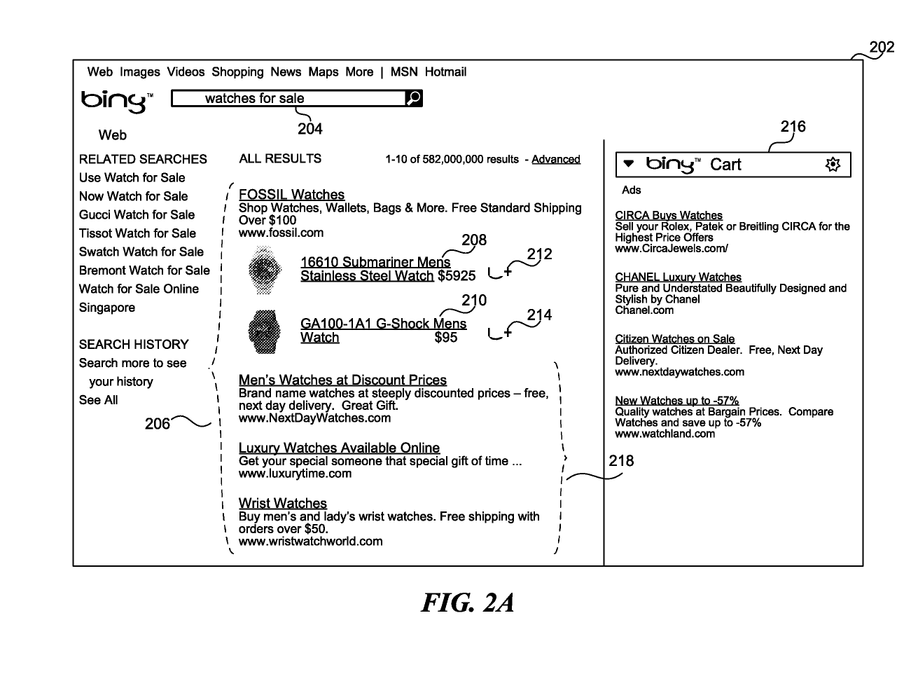

To further illustrate the novel aspects of providing an item list to a user, we turn now to FIG. 2. FIG. 2A is a pictorial diagram illustrating a browser view showing a portion of an exemplary search results page 202 as generated by a search engine 110. As will be discussed, the search results page 202 includes interface devices (e.g., user-actionable controls 212 and 214) through which a computer user can add an item from the search results page to the computer user's item list. Yet another interface control, user list control 216, enables the computer user to view the items on the computer user's item list.

By way of example (and not limitation), the exemplary search results page 202 was generated in response to the search query 204, “watches for sale.” In response to the search query 204, the search engine 110 obtained corresponding search results that have been included in the search results page 202. As shown in FIG. 2A, the search results 206 include various sponsored advertisements 208-210. As can be seen, the sponsored advertisements 208-210 have an appearance of being a search result and are placed in close proximity to the non-sponsored search results 218. In other words, the sponsored advertisements 20-210 are displayed as if they are a part of the typical non-sponsored search results 218. As those skilled in the art will appreciate, an advertiser pays the search engine 110 a certain amount to include the sponsored advertisement in the search results page 202.

According to aspects of the disclosed subject matter, in order to enable a computer user to place/include an item onto the computer user's item list, the search results page 202 is generated such that there are user-actionable controls 212-214 placed on the search results page proximate to items that can be placed on the list. For example, proximate to sponsored advertisements 208-210 are user-actionable controls 212-214. When activated, the user-actionable controls 212 and 214 cause that entries for the corresponding items (e.g., sponsored advertisements 208 or 210) are placed on the computer user's item list. While not shown in FIG. 2A, it should be appreciated that, in at least one embodiment of the disclosed subject matter, user-actionable controls may also be placed proximate to non-sponsored search results for the purpose of adding an entry for the corresponding item to the computer user's item list.

Also shown in FIG. 2A is a user list control 216 by which a computer user can access and/or view items on the computer user's corresponding item list. According to various embodiments of the disclosed subject matter, the computer user's item list is not part of the search results page 202 but, rather, the user list control 206 is configure to access the list from the service that hosts the item list for the computer user and present the items on the list to the computer user. For illustration purposes, we can assume that the computer user added an entry corresponding to sponsored advertisement 210 on the computer user's item list via user-actionable control 212. After activating the user list control 216, the items (in this illustrated example just one item, item 210) entered onto the computer user's item list are displayed. As shown in FIG. 2B, an item list view 220 corresponding to the computer user's item list is displayed. According to one, non-limiting embodiment, the item list view 220 is a drop-down view of the items store on the computer user's item list.

As shown in FIG. 2B, the item list view 220 includes a single item entry corresponding to sponsored advertisement 210. The item entry stored on the computer user's item list comprises information regarding the item, including but not limited to, a description of item, the advertiser offering the item, an advertised price 222 (i.e., the price of the item when an entry for the item was placed on the computer user's item list), a user amount field 224 in which a user can specify an amount for which the user is willing to obtain the item, a counter-offer field 226 in which a counter-offer from the advertiser can be stored, and the like.

According to various aspects of the disclosed subject matter, the user amount stored in the user amount field 224 is optionally supplied by the computer user and, when present, may be used by the search engine 110 to monitor the price of the item for the computer user. For example (as shown in FIG. 2B), the computer user has specified a user amount of $30 as shown in user amount field 224. The search engine 110, upon receiving a user amount that is less than the advertised price for an item (such as advertised price 222) will periodically determine a current price for the item and, if the determined current price from the corresponding advertiser is less than or equal to the user amount specified for the item, the search engine will provide notification to the computer user of the availability of the item at or below the specified user amount. User notification may be made in any number of manners and is not tied to a particular search results page. In other words, monitoring and maintaining an item list is independent of a search results page 202 from whence an item entry may be added to the computer user's item list.

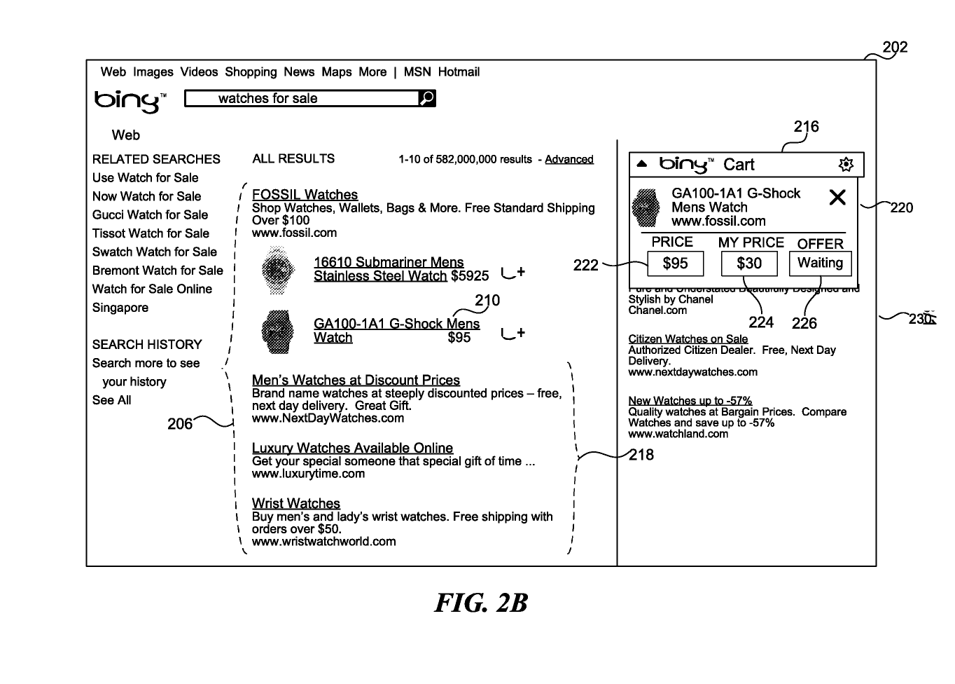

FIG. 3 is a pictorial diagram illustrating an exemplary browser view 300 that includes illustrative notification tools for providing notice of a counter-offer from an advertiser. As showing in FIG. 3, by selecting a user interface control 302 a drop-down view 304 is displayed which indicates the presence of a counter-offer. Similarly, user list control 308 may include an indication 306 that a counter-offer has been received (and will be displayed as part of the computer user's item list.)

Regarding the items on a computer user's item list, it is anticipated that the computer user is given control over what is and is not placed in the computer user's item list. The computer user can both add and delete items from the user's own item list. The computer user is also able to modify user-specified information (such as the user amount) associated with any item on the computer user's item list. Further still, as the items on a computer user's item list represent personal information to the computer user, in at least some embodiments the computer user is given control over whether or not advertisers are able to view any or all of the contents of the computer user's item list, as well as whether or not the computer user is willing to accept counter-offers from advertisers of items on the item list.

In addition to, or as an alternative to, monitoring the current price of an advertised item, in at least one additional embodiment the search engine 110 may provide a mechanism by which an advertiser can make a counter offer to a computer user's user amount. As shown in FIG. 2B, each item on the item list may also include a counter-offer (as shown in counter-offer field 226.) In response to the computer user including a user amount with an item on the item list, an advertiser of the item may make a counter-offer to the computer user. Typically, the counter-offer would be more than the user amount and less than the advertised price, though there is no limitation that this must be so. In any event, if to an advertiser has made a counter-offer, the item list view 218 will display the amount of the counter-offer. In the present example, the counter-offer field 226 indicates that a counter-offer has not yet been received.

In further embodiments of the disclosed subject matter, an advertiser may wish to place an expiration period on any counter-offer such that the counter-offer is valid only until the expiration date specified by the advertiser. Of course, while expiration date implies entire days, in various embodiments the “expiration date” that an advertiser may optionally associate with a counter-offer may be based on a day as well as a time of day. For its part, the search engine 110 includes one or more components that monitor the counter-offers (notifying a computer-user of a counter-offer) as well as any expiration dates associated with any counter-offer. In this manner, the search engine 110 becomes the bargaining platform for, or nexus between, the computer user and the advertiser.

According to various aspects of the disclosed subject matter, in order to make the provision, maintenance and monitoring of an item list for multiple computer users financially, the search engine 110 may monetize certain functionality of hosting one or more item lists. For example, a search engine 110 can initially monetize the search services through the use of sponsored advertisements. In other words, the search engine 110 will charge the advertiser an amount for placing a sponsored advertisement (such as sponsored advertisements 208 and 210 of FIG. 2A) on a search results page 202. In addition to any click-through monetization that may also occur, the search engine 110 may also charge the advertiser an “add to list” amount when a computer user adds an entry for an item to the computer user's item list. The rationale for this charge is that the computer user is engaging the advertisement to a greater degree than simply viewing it on a search results page 202; hence an additional charge can accrue to the advertiser. If the computer-user includes a user amount with an item added to the user's item list, this may constitute yet an additional charge, again the basis being heightened computer user engagement and interest in the specific item. Advertisers may be notified when a user includes a user amount with an item and further charged a “counter-offer” charge when the advertiser provides a counter-offer to the user. Further monetization may occur in regard to completing a transaction on behalf of an advertiser.

While FIGS. 2A, 2B and 3 are made with regard to general search services provided by a search engine 110, it should be appreciated that this is illustrative and not intended as limiting. Aspects of the disclosed subject matter may be implemented in the context of a general search engine/service as well as vertical search services, i.e., those specifically directed to commerce. Moreover, the disclosed subject matter is not simply limited to a search context. Indeed, in at least one alternative embodiment, a plug-in module operating in the context of an Internet browser may scan the contents of a web page, identify items that are for sale or lease, and provide controls or other means such that a computer user can add an entry for an item viewed in the browser to the user's item list.

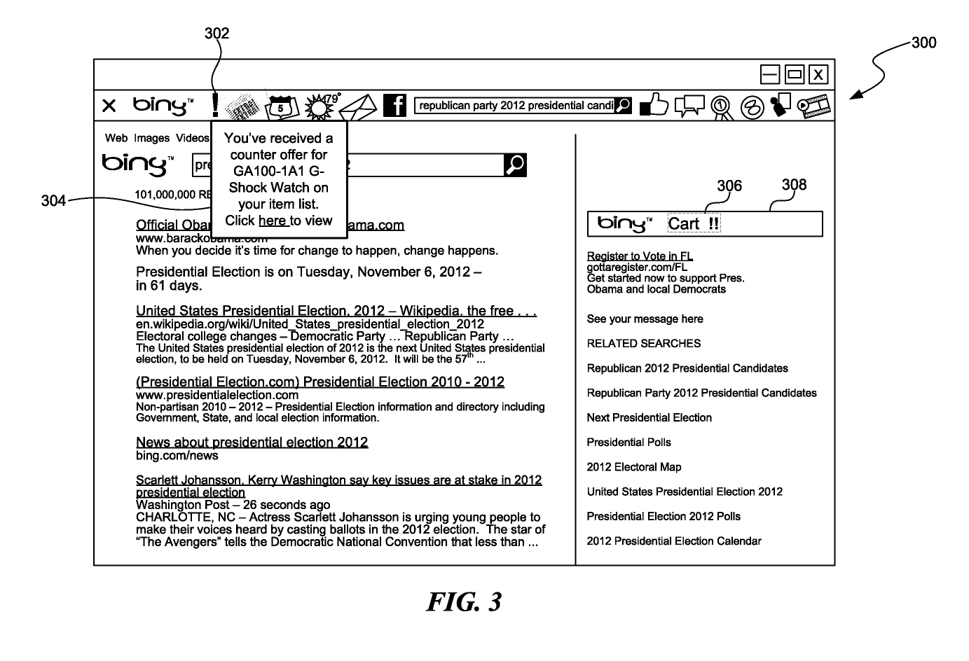

Turning now to FIG. 4, this figure is a flow diagram illustrating an exemplary routine 400 for adding an item (such as a sponsored advertisement) from a search results page to an item list corresponding to the computer user. Beginning at block 402, a search query is received from a computer user. At block 404, the search engine 110 obtains search results from its content store that are relevant to the search query.

At block 406, a search results page 202 is generated. The search results page 202 is generated based on all or some (i.e., a subset) of the search results obtained from the search engine's content store. In at least one embodiment, the search results page is generated to include one or more sponsored advertisements of specific items. Proximate to at least one sponsored advertisement is a user-actionable control which, when activated, causes an entry corresponding to the item to be placed on the computer user's item list. At block 408 the generated search results page is returned to the computer user in response to the search query.

At block 410 the search engine (or other process/service providing and maintaining the item lists) receives notice of activation of the user-actionable control. Thus, at block 412, the corresponding item (corresponding to the user-actionable control that was activated) is added the computer user's item list. As mentioned above, when an item is added to the user's item list, it includes (by way of illustration and not limitation) an identification of the item, the advertiser/promoter of the item, and a current advertised price for the item. Additionally, the added item may also include a user amount identifying the amount that the user would be willing to pay for the particular item. Thereafter, the routine 400 terminates.

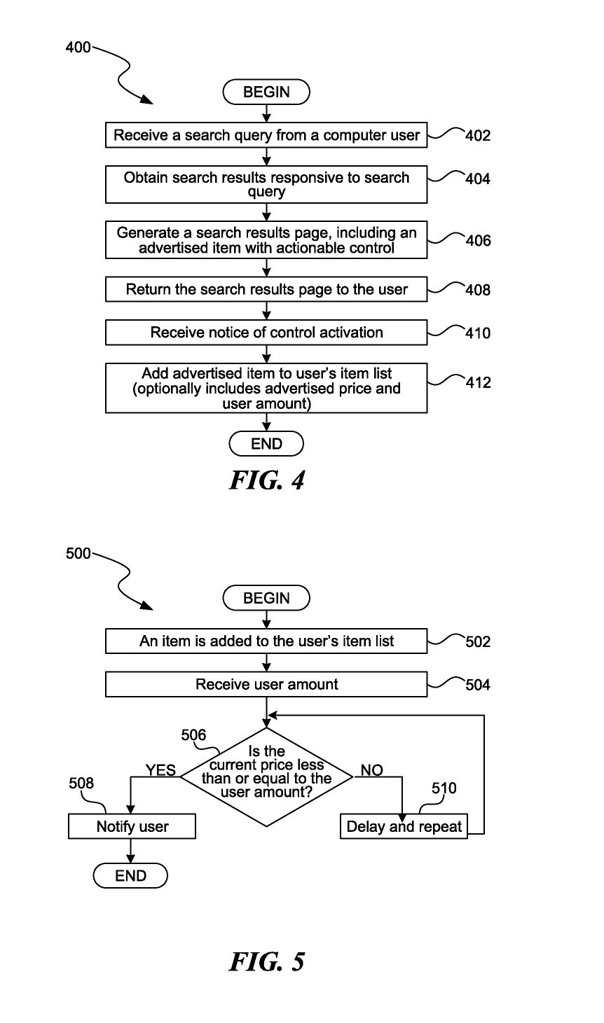

According to aspects of the disclosed subject matter, certain options may be carried out upon adding an item to a computer user's item list. One of the options that a search service, such as provided by search engine 110, may provide with regard to an item list is to monitor the price of the items on the list. To this end, FIG. 5 is a flow diagram illustrating an exemplary routine 500 for monitoring a user amount associated with an item on a computer user's item list and notifying the computer user when the current price of the item is at or below the user amount. Beginning at block 502, an item is added to computer user's item list. At block 504, a user amount is received for the item and associated with the item on the item list.

At block 506, a loop is commenced to be periodically executed, wherein the current price of the item is obtained and a determination is made as to whether or not the current price is at or below the user amount obtained from the computer user for this item. If the current price is at or below the user amount, at block 508 the computer user is notified of the current price (that it is at or below the user amount). Thereafter, the routine 500 may terminate. Optionally, however (now shown), the loop may continue until the computer user purchases the item, removes the item from the user's item list, or a predetermined expiration date expires. Of course, in at least one embodiment, if an item is purchased and/or removed from the item list, the routine 500 would be terminated without further execution.

If, at block 506, the current price is above the user amount, the routine 500 proceeds to block 510 where the routine 500 delays for an appropriate amount of time and then returns again to decision block 506.

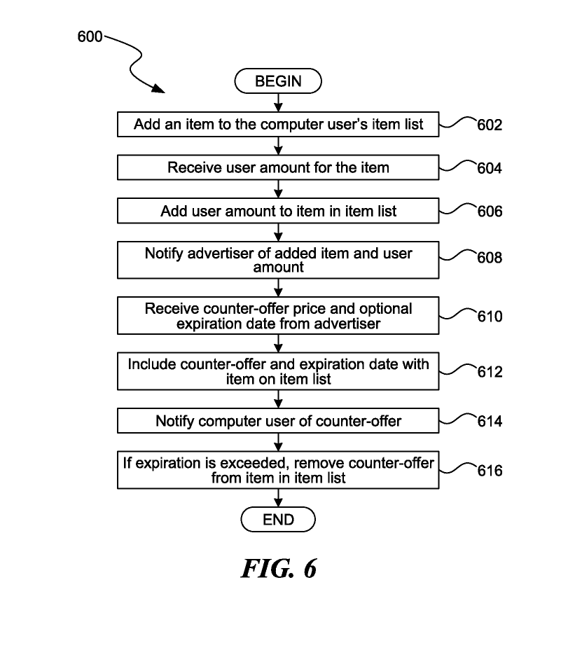

As mentioned above, in addition to or as an alternative to monitoring the current price for an item on the computer user's item list, a search engine 110 may also be configured to provide the basis for bargaining between the computer user and the advertiser. FIG. 6 is a flow diagram illustrating an exemplary routine 600 in which an advertiser can provide a counter-offer to a computer user with regard to a user amount included with an item on the computer user's item list. Beginning at block 602, an item is added the computer user's item list. At block 604, a user amount associated with the added item is received. At block 606, the user amount is included with the item on the computer user's item list.

At block 608, the advertiser (associated with the added item) is notified of the addition of the item to the computer user's item list. At block 610, a counter-offer is received from the advertiser countering the user amount included with the item on the item list. At block 612, the counter-offer is included with the item in the item list. As mentioned above, an expiration date may be optionally associated with the counter-offer and, if present, included with the counter-offer in the item on the item list.

At block 614, the computer user is notified of the advertiser's counter-offer. At block 616, a process is optionally (dependent on the presence of an expiration date) begun to monitor for the expiration of the counter-offer such that the counter-offer is no longer valid to the computer user if the expiration date (and time) has passed. Thereafter, the routine 600 terminates.

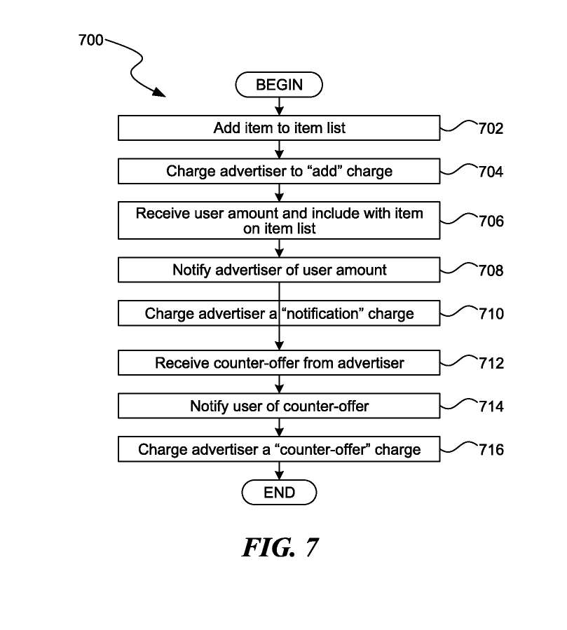

FIG. 7 is a flow diagram illustrating an exemplary routine 700 for monetizing a computer user's use of an item list. Beginning at block 702, an item (such as a sponsored advertisement) is added the computer user's item list. At block 704, the advertiser is charged an “add” charge by the search engine 110 for having added the sponsored item to the item list. At block 706, a user amount is received from the computer user and added to the information associated with the item in the item list. At block 708, the advertiser associated with the item added to the item list is notified of the addition of the user amount to the item on the item list. At block 710, the advertiser is charged a “notification” charge.

At block 712, a counter-offer is received from the advertiser with regard to the item on the item list. At block 714, the computer user is notified of the counter-offer (as discussed above.) At block 716, the advertiser is charged a “counter-offer charge” in association with the counter-offer and notifying the computer user. Alternatively, the “counter-offer charge” may be applied only when the computer user accepts the counter offer and proceeds with the transaction. According to various embodiments of the disclosed subject matter, this may be applied with the transaction, which could be placed on the search results page, on a special transaction page, or on the advertiser's payment page. Thereafter, the routine 700 terminates.

With regard to the counter-offers and user amounts, it should be appreciated that while just one user amount and counter-offer are received (as described above), it should be appreciated that additional user amounts and/or counter-offers may be received. These may take the form of negotiation rounds. Accordingly, though only one “round” of user amount and counter-offer is described above, it should be appreciated that this is illustrative and not limiting upon the disclosed subject matter.

In regard to additional rounds of negotiation, if after the “first round” of negotiation the computer user and vendor/advertiser are unable to come to an agreement on price, the hosting system that maintains the computer user's item list may permit the advertiser to continue to bargain with the computer user by submitting (if desired by the advertiser) yet another counter offer to the computer user. In at least one embodiment, the advertiser would be charged another “counter-offer charge” for submitting yet another counter offer to the computer user. Alternatively (or in combination with the advertiser's efforts to reach an agreement with the computer user) the hosting system may (optionally) permit other vendors to either accept the computer user's user amount as the price for the item or submit its own counter offer to the computer user. As with the advertiser, the other vendors may be required to pay a “counter offer charge” or bid for the opportunity to make the counter offer to the computer user (with the hosting system selecting the most advantageous bid). Similarly, if after the first round of negotiation fails, the advertiser/vendor may be placed on equal footing with regard to other vendors and be required to bid for continued access to the computer user to continue the negotiation process.

Regarding the routines of FIGS. 4-7, it should be appreciated that while they are expressed with discrete steps in carrying out the functionality of the routines, these steps should be viewed as being logical in nature and may or may not correspond to any actual and/or discrete steps. Nor should the order that these steps are presented in the various, illustrative routines be construed as the only order in which the steps may be carried out. Further, those skilled in the art will appreciate that logical steps may be combined together or be comprised of multiple steps. Steps may be carried out in parallel or in series. Often, but not exclusively, the functionality of these routines are embodied in software (e.g., applications, system services, libraries, and the like) that is executed on computer hardware such as the user computers 102-106 described above.

While novel aspects of the disclosed subject matter are expressed in routines and/or methods, these aspects may also be embodied in computer-readable media (also referred to as computer-readable storage media). As those skilled in the art will appreciate, computer-readable media can host computer-executable instructions for later retrieval and execution. When executed on a computing device, the computer-executable instructions stored on one or more computer-readable storage devices carry out various steps or methods, including those steps, methods, and routines described above. Examples of computer-readable media include, but are not limited to: optical storage media such as digital video discs (DVDs) and compact discs (CDs); magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this document, however, computer-readable media expressly excludes carrier waves and propagated signals.

Turning now to FIG. 8, this figure is a block diagram illustrating a search engine 110 configured to provide a computer user with an item list. The search engine 110 includes a processor 802 and a memory 804. As those skilled in the art will readily appreciate, the processor 802 executes instructions retrieved from the memory 804 in carrying out various aspects of the search engine service including, but not limited to, responding to search queries and providing item lists for computer users.

The search engine 110 also includes a communications component 806 through which the search engine sends and receives communications over the network 108. For example, it is through the communication component 806 that the search engine 110 receives search queries from computer users, instructions to add an item to the computer user's item list, receive a user amount corresponding to an item, and notifies the computer user that a current price for an item on the item list is at or below the user amount or that a counter-offer has been received. Further, it is through the communication component 806 that the search engine 110 communicates with one or more advertisers, such as advertisers 112-116.

The search engine 110 further includes a search results retrieval component 808 and a search results page generator 810. Regarding the search results retrieval component 808, this logical component is responsible for retrieving, or obtaining, search results information relevant to a computer user's search query from a content store 814 associated with the search engine 110. The search results page generator 810 generates one or more search results pages from the search results obtained by the search results retrieval component 808 as well as advertisements from advertisers, including one or more sponsored advertisements.

The search engine 110 still further includes an item list manager 812 that carries out the various functions (as described above) of providing and managing item lists for one or more computer users. The item list manager 812 maintains an item list store 816 in which one or more item lists), such as item list 818, are stored (with each item list corresponding to a specific computer user or group). As already described, each item list 818 is comprised of a set of items, such as item 820. As shown (as an example) in FIG. 8, item 820 corresponds to a watch with an advertised price of $95, a user amount set at $75, a counter-offer set at $85, and an expiration date associated with the counter offer set at Nov. 13, 2012.

It should be appreciated, of course, that many (if not all) of these components should be viewed as logical components for carrying out various functions of a suitably configured search engine 110 in providing an item list to one or more computer users. These logical components may or may not correspond directly to actual components. Moreover, in an actual embodiment, these components may be combined together or broke up across multiple actual components. Further still, these components (both logical and actual) may be distributed across one or more cooperative computer systems.

As previously mentioned, an item list may be made accessible to the computer user outside of the context of a search engine. Indeed, quite often a computer user will be browsing one or more web pages on the Internet and encounter an item, potentially for sale or lease that the computer user may wish to acquire. Alternatively, a user may be shopping online and encounter an item at a site and wish to perform some comparison shopping with items at other web locations. According to aspects of the disclosed subject matter, rather than having the computer user visit other sites to compare whether the item is offered at a desirable price, the computer user should be able to add the item to the user's item list independent of whether or not the computer user is viewing search results. Further, by adding the item to the computer user's item list, multiple vendors may be given an opportunity to provide the item to the user, not just an advertiser on a search results page.

According to aspects of the disclosed subject matter, as a computer user views a particular web page through a browser application (or some other program for viewing content on the Internet), the computer user can initiate a process that extracts information from the currently viewed web page. The extracted information is then presented to the computer user for selection (as some of the extracted information may not be directed to an item for purchase or there may be multiple items for purchase on a single web page.) After selection, the user can then cause the selected item (or items) to be added to the computer user's item list. Various vendors can then be notified of the added item to the item list and make an offer to the computer user for the item. In an alternative embodiment, a process may automatically execute which extracts or identifies items on a currently-viewed web page such that the computer user is able to add the item to the computer user's item list.

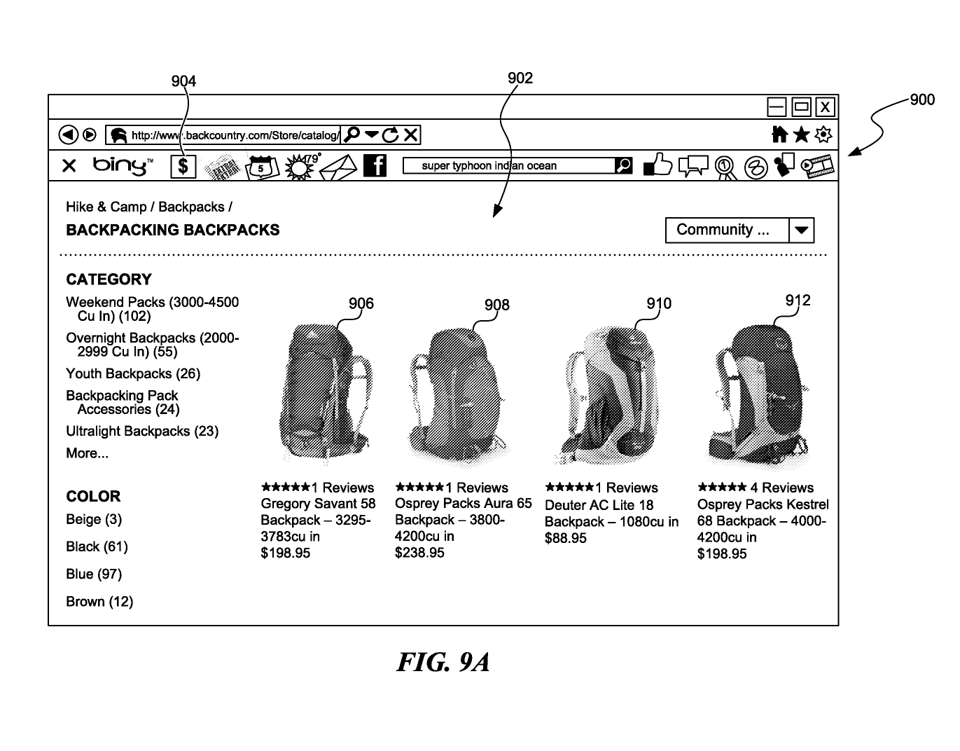

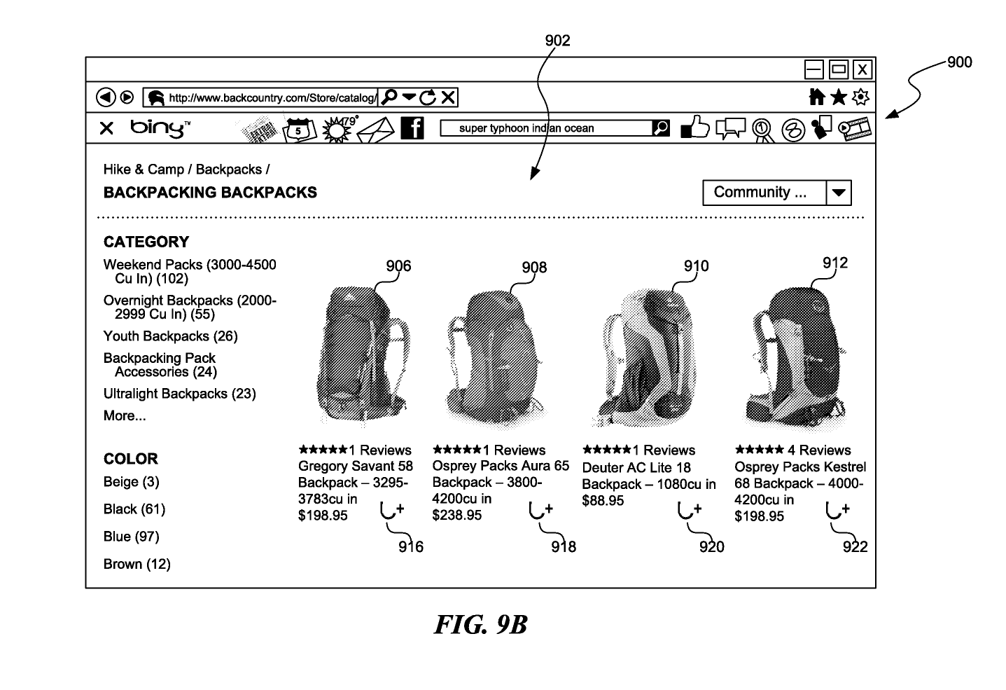

Turning first to the a user-initiated process, FIG. 9A is a pictorial diagram illustrating an browser view 900 of a web page 902 with a user-actionable control 904 configured to initiate a process to extract item information from the currently-viewed web page. As shown in FIG. 9A, the currently-viewed web page 902 includes several backpacks 906-912 that are available for purchase. The browser view 900 includes an icon bar 914 that includes a user-actionable control 904 which, for this example, is configured to initiate a process for extracting item information from the currently-viewed web page 902 and presenting the extracted item information to the computer user for selection (to add to the computer user's item list.) Thus, upon activation/selection, the process scans the currently viewed web page, identifies items available to the computer user, and presents the extracted information to the computer user.

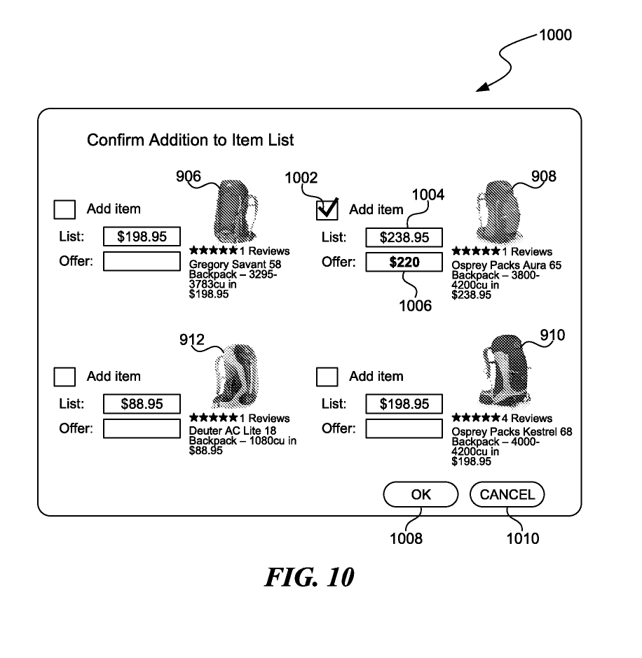

FIG. 10 is a pictorial diagram illustrating an item information view 1000 containing item information extracted from the currently-viewed web page 902 of FIG. 9A. As can be seen, the item information view 1000 includes item information regarding the backpacks 906-912 from web page 902. Additional item information can be extracted by the process mentioned above, including a current list price (such as illustrated in field 1004) and metadata corresponding to an item. As shown in FIG. 10, the computer user is provided with an option (for each identified item in the item information view 1000), such as checkbox 1002, to provide an indication to the process to add an entry corresponding to the item on the computer user's item list. In addition to selecting items for addition to the computer user's item list, the computer user is also given an opportunity to optionally provide a user amount (such as shown in field 1006). Also included in the item information view 1000 are controls 1008-1010. For control 1008, should the computer user select one or more the items 906-912 for addition to the computer user's item list, then by selecting control 1008 the selected items are added to the item list. Alternatively, by selecting control 1010 none of the extracted items are added to the list at that time.

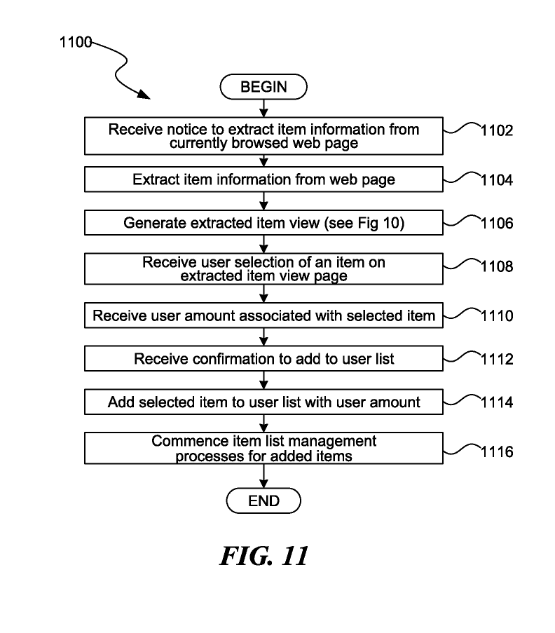

Turning now to FIG. 11, this figure is a flow diagram illustrating an exemplary routine 1100 for adding entries corresponding to items from a web page onto a computer user's item list from a confirmation view. Beginning at block 1102, notice is received initiating the process to extract item information from the currently-viewed web page 902. Correspondingly, at block 1104, item information is extracted from the currently-viewed web page. At block 1106, an item information view 1000 is generated from the extracted item information.

At block 1108, a computer user selection of an item on the item information view 1000 is received. At block 1110, an optional user amount is received with regard to the selected item. At block 1112, confirmation is received to add an entry corresponding to the selected item on the computer user's item list. At block 1114, an entry corresponding to the selected item, optionally including a user amount and other item information, is added to the computer user's item list. At block 1116, the item list management processes are commenced for the added items. These include but are not limited to: notifying one or more providers of the added items of the addition of the added items; monitoring a current price for the added items, especially in when a corresponding user amount is optionally supplied; receiving counter-offers from one or more item providers, and the like. Thereafter, the routine 1100 terminates.

Just as mentioned above in regard to the routines of FIGS. 4-7, it should be appreciated that while routine 1100 of FIG. 11 is expressed with discrete steps, these steps should be viewed as being logical in nature and may or may not correspond to any actual and/or discrete steps. Nor should the order that these steps are presented in the various, illustrative routines be construed as the only order in which the steps may be carried out. Further, those skilled in the art will appreciate that logical steps may be combined together or be comprised of multiple steps. Steps may be carried out in parallel or in series.

Of course, a user-initiated process that extracts information from a currently-viewed web page 902 is just one manner to present items to a computer user for addition to the computer user's item list. In an alternative embodiment, a process may automatically execute and identify items on a web page that may be added to an item list. Turning to FIG. 9B, FIG. 9B is a pictorial diagram illustrating an alternative browser view 900 of the web page 902 of FIG. 9A in which item on the currently-viewed web page are automatically identified. Rather than a computer user initiating an extraction process, an extraction process is automatically initiated. The functionality of initiating an automated process may be incorporated within the browser application itself, may be implemented through a browser plug-in, or may be implemented in a process or thread that executes external to the browser but is able to act in cooperation with the browser.

In the present example of FIG. 9B, rather than extracting all item information from the page and presenting an extracted item view to the user, user-actionable controls 916-922 are located proximate to the items 906-912 that can be added to the computer user's item list, similar to the user actionable icons of FIGS. 2A and 2B described above. By activating (e.g., clicking) a user-actionable control (e.g., any of controls 916-922), an entry for the corresponding item is added to the computer user's item list. As mentioned above, once an item is added to the computer user's item list, various management processes begin.

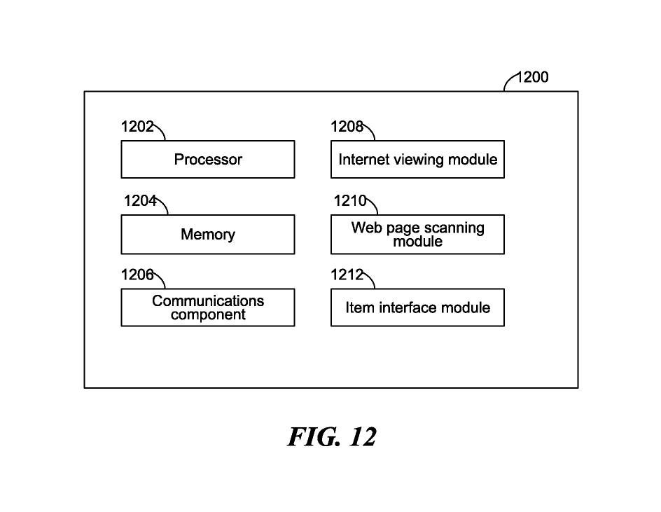

As indicated above, some or all of the aspects of the disclosed subject matter may be implemented outside of a search results page and, therefore, outside of the control of a search engine 110. Accordingly, FIG. 12 is a block diagram illustrating exemplary components of a computing system 1200 suitably configured to implement aspects of the disclosed subject matter, and particularly the user-facing aspects of the disclosed subject matter. The computing system 1200 (which may be implemented on any of user computers 102-106) includes a processor 1202 and a memory 1204. As those skilled in the art will readily appreciate, the processor 1202 executes instructions retrieved from the memory 1204 in carrying out various aspects of the user-facing computing system.

The computing system 1200 also includes a communications component 1206 through which the computing system sends and receives communications over the network 108. For example, it is through the communication component 1206 that the computing system 1200 views web pages on the Internet, some of these web pages including items that the computer user may wish to add to the computer user's item list.

Also including in the computing system 1200 an internet viewing module 1208. It is through the internet viewing module 1208 that the computer user is able to view the various web pages that may or may not include items for sale. The internet viewing module 1208 also enables the computer user to interact with the search engine 110 in submitting search queries and viewing search results. A web browser application is one, non-limiting embodiment of an internet viewing module 1208. The computer system 1200 also includes a web page scanning module 1210. The web page scanning module 1210 is configured to scan a web page that is currently displayed by the internet viewing module 1208 and identify items that may be added to the computer user's item list. The web page scanning module 1210 may be implemented to operate manually (as initiated by a computer user) or automatically, as discussed above in regard to FIGS. 9A and 9B.

Still further included in the computing system 1200 is an item interface module 1212 that interfaces with the user in presenting items scanned from the current web page and, upon indication by a computer user, causes entries for items to be added to the computer user's item list. In one embodiment, the item interface module 1212 presents and supports the item information view 1000 of FIG. 10 discussed above.

While various novel aspects of the disclosed subject matter have been described, one should appreciate that these aspects are exemplary and should not be construed as limiting. Variations and/or alterations to the various aspects may be made without departing from the scope of the disclosed subject matter.

What is claimed:

1. A computer-implemented method for providing a vendor-independent item list to a computer user, the method comprising:
providing an item list corresponding to a computer user, wherein the item list is configured to include a set of items offered by vendors;
receiving a first indication initiated by the computer user viewing a web page on a computing device, wherein the vendor of the web page is unassociated with providing the item list to the computer user;
identifying item information for one or more items included in the web page;
presenting an item information view comprising the one or more items included in the web page;
receiving a selection of an item of the one or more items of the item information view; and
adding the selected item to the item list corresponding to the computer user.

2. The computer-implemented method of claim 1, wherein the item list is provided by a search engine.

3. The computer-implemented method of claim 1, wherein receiving the selection of the item comprises receiving the selection of the item and a corresponding user amount, and wherein adding the selected item to the item list comprises adding the selected item to the item list corresponding to the computer user with the user amount.

4. The computer-implemented method of claim 3, wherein adding the selected item to the item list further comprises adding the selected item to the item list with a vendor price associated with the selected item obtained from the web page.

5. The computer-implemented method of claim 3, wherein adding the selected item to the item list further comprises adding the selected item to the item list with vendor information identifying the vendor associated with the web page.

6. The computer-implemented method of claim 3 further comprising notifying a plurality of vendors who offer the selected item that the selected item was added to the computer user's item list.

7. The computer-implemented method of claim 6 further comprising:
receiving an offer price for the selected item from one of the plurality of vendors; and
notifying the computer user that an offer price has been received.

8. The computer-implemented method of claim 7, wherein the offer price is associated with an expiration period after which the offer price is no longer available to the computer user.

9. A computer-readable medium bearing computer-executable instructions which, when executed on a computing system comprising at least a processor retrieved from the medium, carry out a method for providing a vendor-independent item list to a computer user, the method comprising:
providing an item list corresponding to a computer user, wherein the item list is configured to include a set of items offered by vendors;
receiving a first indication initiated by the computer user viewing a web page on a computing device, wherein the vendor of the web page is unassociated with providing the item list;
identifying item information for one or more items included in the web page;
presenting an item information view comprising the one or more items included in the web page;
receiving a selection of an item of the one or more items of the item information view; and
adding the selected item to the item list corresponding to the computer user.

10. The computer-readable medium of claim 9, wherein the item list is provided by a search engine.

11. The computer-readable medium of claim 9, wherein receiving the selection of the item comprises receiving the selection of the item and a corresponding user amount, and wherein adding the selected item to the item list comprises adding the selected item to the item list corresponding to the computer user with the user amount.

12. The computer-readable medium of claim 11, wherein adding the selected item to the item list further comprises adding the selected item to the item list with a vendor price associated with the selected item obtained from the web page.

13. The computer-readable medium of claim 11, wherein adding the selected item to the item list further comprises adding the selected item to the item list with vendor information identifying the vendor associated with the web page.

14. The computer-readable medium of claim 11, wherein the method further comprises notifying a plurality of vendors who offer the selected item that the selected item was added to the computer user's item list.

15. The computer-readable medium of claim 14, the method further comprises:
receiving an offer price for the selected item from at least some of the plurality of vendors; and
notifying the computer user that an offer price has been received.

16. The computer-readable medium of claim 14, the method further comprises:
receiving an offer price for the selected item from at least some of the plurality of vendors;
identifying the lowest offer price for the selected item and the corresponding vendor;
including the offer price and the corresponding vendor with the selected item on the computer user's item list; and
notifying the computer user that an offer price has been received.

17. The computer-readable medium of claim 16, wherein the offer price is associated with an expiration period after which the offer price is no longer available to the computer user, and wherein the expiration period is also included with the selected item on the computer user's item list.

18. A computer-implemented system for facilitating a vendor-independent item list for a computer user, the system comprising a processor and a memory, wherein the processor executes instructions stored in the memory as part of or in conjunction with additional components to facilitate the vendor-independent item list for a computer user, the additional components comprising:
a communication component by which the computer system communicates with the computer user and one or more vendors over a network;
an Internet viewing module for viewing web pages on the Internet;
a web page scanning module that scans a web page viewed by the Internet viewing module to identify item information on the scanned web page, the item information including a set of items available for acquisition by the computer user from a vendor;
an item interface module configure to:
receive a selection from the computer user of an item from the set of items available for acquisition; and
cause the selected item to be added to computer user's item list.

19. The computer system of claim 18, wherein the web page scanning module operates automatically as the Internet view module views a web page.

20. The computer system of claim 18 further comprising a user-actionable control, and wherein the web page scanning module scans the web page currently being presented by the Internet view module upon activation of the user-actionable control.
